(19) United States
(12) Patent Application Publication
(10) Pub. No.: US 2011/0188715 A1
(43) Pub. Date: Aug. 4, 2011

(54) Automatic Identification of Image Features

(75) Inventors: Jamie Daniel Joseph Shotton, Cambridge (GB); Antonio Criminisi, Cambridge (GB)

(73) Assignee: Microsoft Corporation, Redmond, WA (US)

(21) Appl. No.: 12/697,785

(22) Filed: Feb. 1, 2010

(51) Int. Cl. G06K 9/00

(52) U.S. Cl. 382/128

(57) ABSTRACT

Automatic identification of image features is described. In an embodiment, a device automatically identifies organs in a medical image using a decision forest formed of a plurality of distinct, trained decision trees. An image element from the image is applied to each of the trained decision trees to obtain a probability of the image element representing a predefined class of organ. The probabilities from each of the decision trees are aggregated and used to assign an organ classification to the image element. In another embodiment, a method of training a decision tree to identify features in an image is provided. For a selected node in the decision tree, a training image is analyzed at a plurality of locations offset from a selected image element, and one of the offsets is selected based on the results of the analysis and stored in association with the node.

### BACKGROUND

Computer-rendered images can be a powerful tool for the analysis of data representing real-world objects, structures and phenomena. For example, detailed images are often produced by medical scanning devices that clinicians can use to help diagnose patients. The devices producing these images include magnetic resonance imaging (MRI), computed tomography (CT), single photon emission computed tomography (SPECT), positron emission tomography (PET) and ultrasound scanners. The images produced by these medical scanning devices can be two-dimensional images or three-dimensional volumetric images. In addition, sequences of two- or three-dimensional images can be produced to give a further temporal dimension to the images. Other non-medical applications, such as radar, can also generate 3D volumetric images.

However, the large quantity of the data contained within such images means that the user can spend a significant amount of time just searching for the relevant part of the image. For example, in the case of a medical scan a clinician can spend a significant amount of time just searching for the relevant part of the body (e.g. heart, kidney, blood vessels) before looking for certain features (e.g. signs of cancer or anatomical anomalies) that can help a diagnosis.

Some techniques exist for the automatic detection and recognition of objects in images, which can reduce the time spent manually searching an image. For example, geometric methods include template matching and convolution techniques. For medical images, geometrically meaningful features can, for example, be used for the segmentation of the aorta and the airway tree. However, such geometric approaches have problems capturing invariance with respect to deformations (e.g. due to pathologies), changes in viewing geometry (e.g. cropping) and changes in intensity. In addition, they do not generalize to highly deformable structures such as some blood vessels.

Another example is an atlas-based technique. An atlas is a hand-classified image, which is mapped to a subject image by deforming the atlas until it closely resembles the subject. This technique is therefore dependent on the availability of good atlases. In addition, the conceptual simplicity of such algorithms is in contrast to the requirement for accurate, deformable algorithms for registering the atlas with the subject. In medical applications, a problem with n-dimensional registration is in selecting the appropriate number of degrees of freedom of the underlying geometric transformation; especially as it depends on the level of rigidity of each organ/tissue. In addition, the optimal choice of the reference atlas can be complex (e.g. selecting separate atlases for an adult male body, a child, or a woman, each of which can be contrast enhanced or not). Atlas-based techniques can also be computationally inefficient.

The embodiments described below are not limited to implementations which solve any or all of the disadvantages of known image analysis techniques.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Automatic identification of image features is described. In an embodiment, a device automatically identifies organs in a medical image using a decision forest formed of a plurality of distinct, trained decision trees. An image element from the image is applied to each of the trained decision trees to obtain a probability of the image element representing a predefined class of organ. The probabilities from each of the decision trees are aggregated and used to assign an organ classification to the image element. In another embodiment, a method of training a decision tree to identify features in an image is provided. For a selected node in the decision tree, a training image is analyzed at a plurality of locations offset from a selected image element, and one of the offsets is selected based on the results of the analysis and stored in association with the node.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a flowchart of a process for training a decision forest to identify features in an image;

FIG. 2 illustrates an example training image;

FIG. 3 illustrates an example portion of a random decision forest;

FIG. 4 illustrates a flowchart of a process for using spatial context in an image;

FIG. 5 illustrates example spatial context calculations for an image element;

FIG. 6 illustrates the application of the spatial context calculations of FIG. 5 in a decision tree;

FIG. 7 illustrates a flowchart of a process for identifying features in an unseen image using a trained decision forest;

FIG. 8 illustrates a viewer application for viewing a medical image; and

FIG. 9 illustrates an exemplary computing-based device in which embodiments of the image processing techniques can be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a general-purpose computing system, the system described is provided as an example and not a limitation. As those skilled in the art will appreciate, the present examples are suitable for application in a variety of different types of dedicated or embedded computing systems or devices.

The techniques below are described with reference to a medical image, which can be a two- or three-dimensional image representing the internal structure of a (human or animal) body (or a sequence of such images, e.g. showing a heart beating). Three-dimensional images are known as volumetric images, and can be generated as a plurality of ‘slices’ or cross-sections captured by a scanner device and combined to form an overall volumetric image. The volumetric image is formed of voxels. A voxel in a 3D volumetric image is analogous to a pixel in a 2D image, and represents a unit of volume. The term ‘image element’ is used herein to refer to either a pixel in a two-dimensional image or a voxel in a three-dimensional image (possibly at an instant in time). Each image element has a value that represents a property such as intensity or color. The property can depend on the type of scanner device generating the image. Medical image scanners are calibrated so that the image elements have physical sizes (e.g. the voxels or pixels are known to have a certain size in millimeters). The scanners are sometimes also calibrated such that image intensities can be related to the density of the tissue in a given portion of an image.

The techniques described provide automatic and semi-automatic tools that produce a ‘body parsing’, i.e. description of what is present in the image and where it is. The description can, for example, include a hierarchy of body parts (e.g. chest→heart→left ventricle) and connections between them (such as blood vessels). The described tools use machine learning techniques to learn from training data how to perform the body parsing on previously unseen images. This is achieved using a decision forest comprising a plurality of different, trained decision trees. This provides an efficient algorithm for the accurate detection and localization of anatomical structures within medical scans. This, in turn, enables efficient viewer applications to be used, where, for instance, a cardiologist simply clicks on a button to be shown canonical views of the aorta, coronary arteries and the valves of an automatically detected heart. This therefore reduces the time spent by a clinician searching through scanned images (often slice by slice for volumetric images) and navigating through visual data. This can also reduce the time spent by a clinician locating a time-isolated structures in a sequence of images, for example the aorta at a particular point in the heart-beat cycle.

The described techniques comprise an efficient algorithm for organ detection and localization which negates the need for atlas registration. This therefore overcomes issues with atlas-based techniques related to a lack of atlases and selecting the optimal model for geometric registration. In addition, the algorithm considers context-rich visual features which capture long-range spatial correlations efficiently. These techniques are computationally simple, and can be combined with an intrinsic parallelism to yield high computational efficiency. Furthermore, the algorithm produces probabilistic output, which enables tracking of uncertainty in the results, the consideration of prior information (e.g. about global location of organs) and the fusing of multiple sources of information (e.g. different acquisition modalities). The algorithm is able to work with different images of varying resolution, varying cropping, different patients (e.g. adult, child, male, female), different scanner types and settings, different pathologies, and contrast-agent enhanced and non-enhanced images.

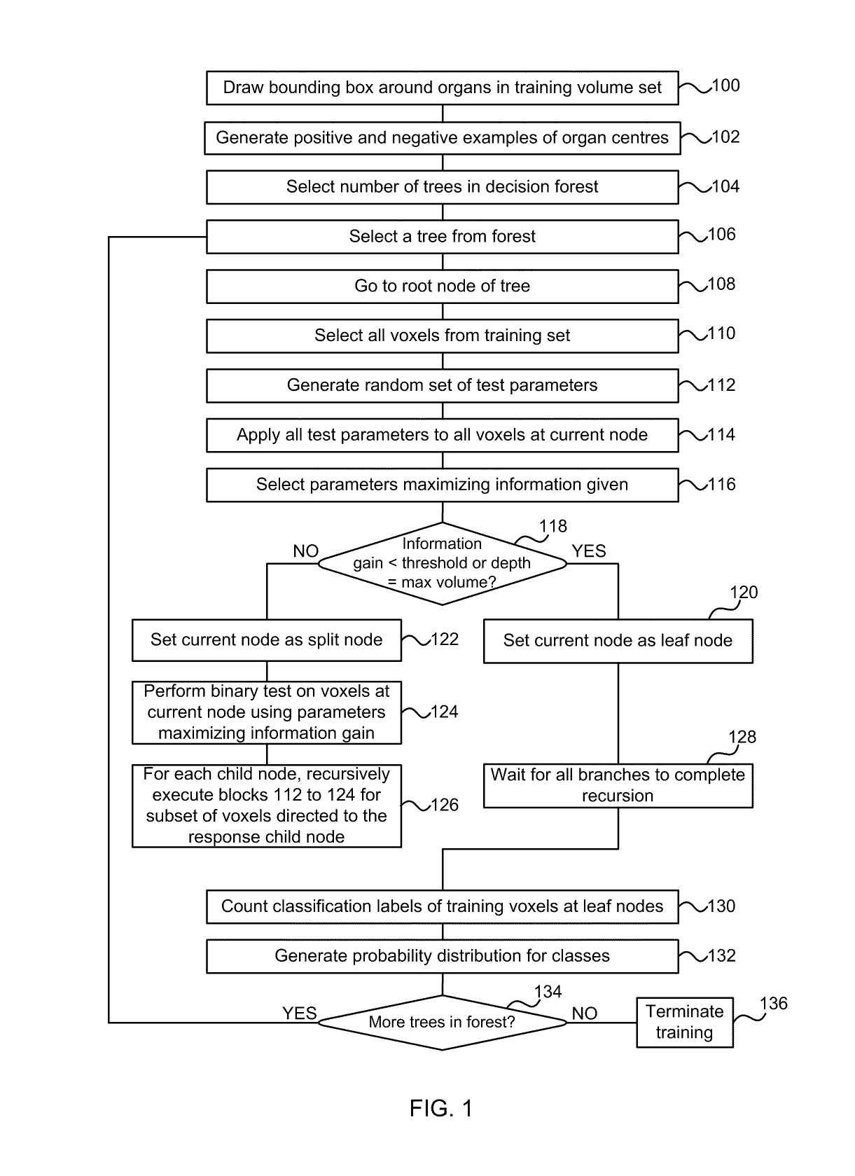

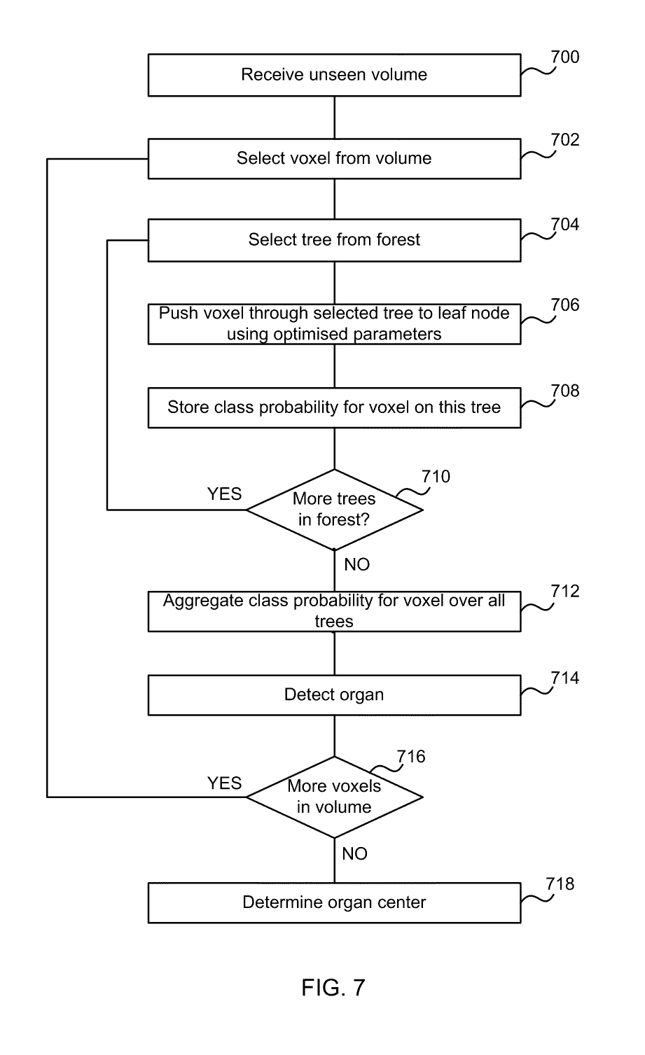

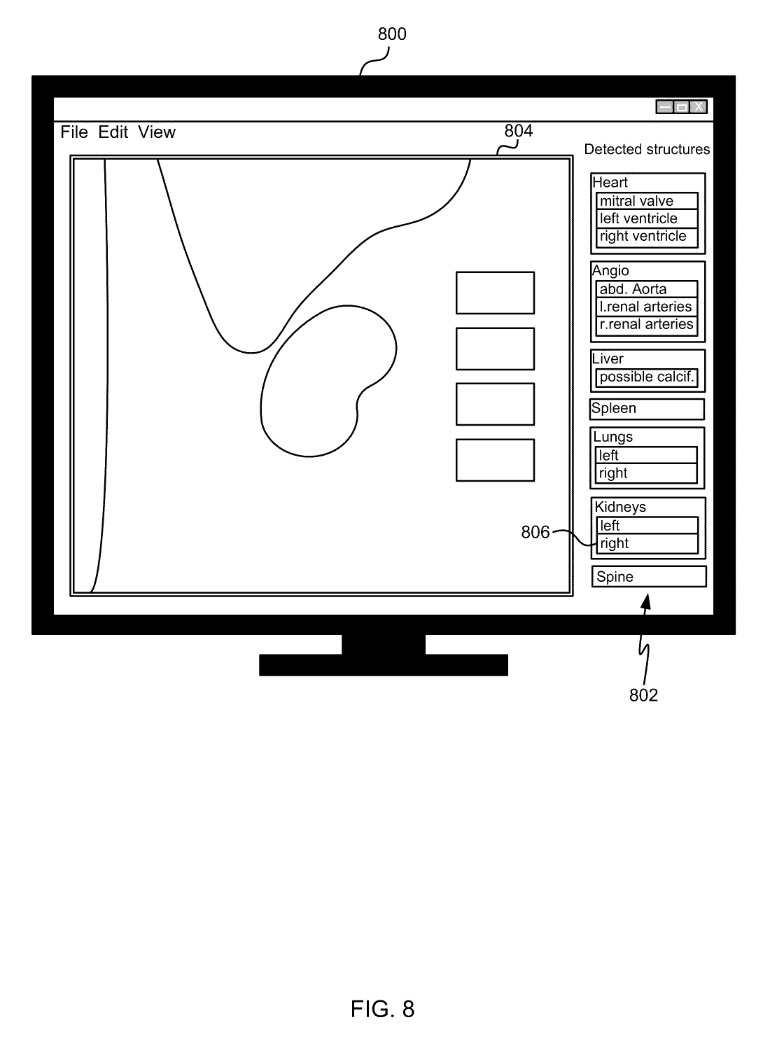

In the description below, firstly a process for training the decision trees for the machine learning algorithm is discussed with reference to FIGS. 1 to 6, and secondly a process for using the trained decision trees for detecting, classifying and displaying organs in a medical image is discussed with reference to FIGS. 7 and 8.

Reference is first made to FIG. 1, which illustrates a flowchart of a process for training a decision forest to identify features in an image. Firstly, a labeled ground-truth database is created. This is performed by taking a selection of training images, and hand-annotating them by drawing 100 a bounding box (i.e. a cuboid in the case of a 3D image, and a rectangle in the case of a 2d image) centered on each organ of interest (i.e. each organ that it is desired that the machine learning system can identify). The bounding boxes (2D or 3D) can also be extended in the temporal direction in the case of a sequence of images. The training images can comprise both contrasted and non-contrasted scan data, and images from different patients, cropped in different ways, with different resolutions and acquired from different scanners

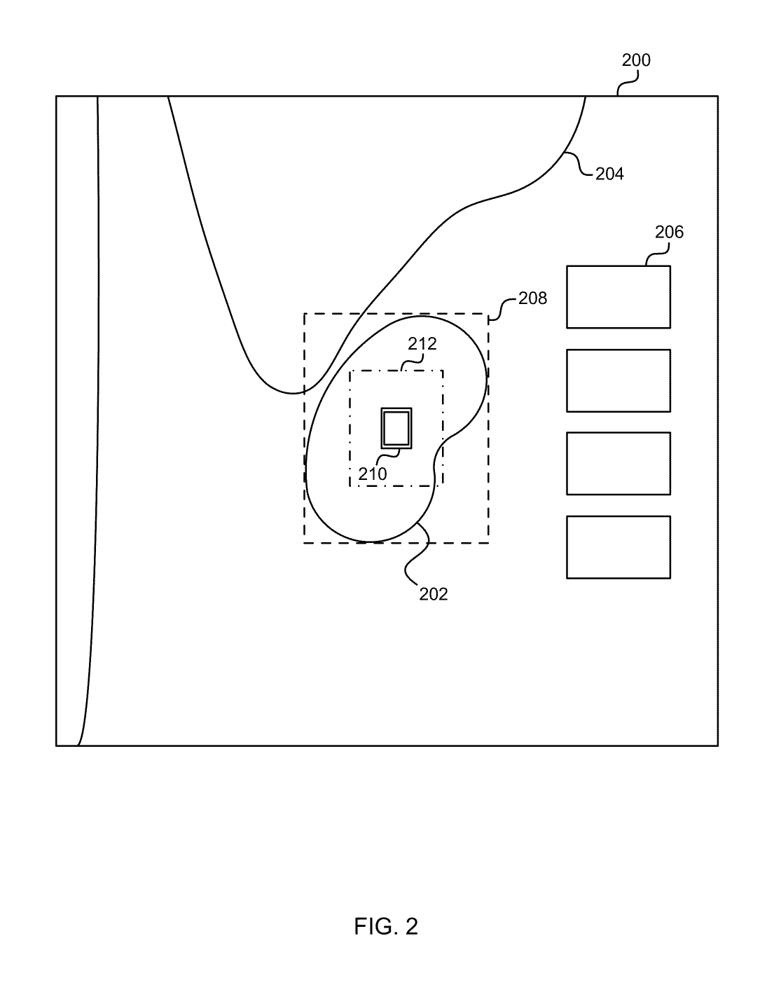

This is illustrated with reference to the simplified schematic diagram of FIG. 2, representing a portion of a medical image 200. Note that the schematic diagram of FIG. 2 is shown in two dimensions only, for clarity, whereas an example volumetric image is three-dimensional. The medical image 200 comprises a representation of several organs, including a kidney 202, liver 204 and spinal column 206, but these are only examples used for the purposes of illustration. Other typical organs that can be shown in images and identified using the technique described herein include (but are not limited to) the head, heart, eyes, lungs, and major blood vessels. A bounding box 208 is shown drawn (in dashed lines) around the kidney 202. Note that in the illustration of FIG. 2 the bounding box 208 is only shown in two dimensions, whereas in a volumetric image the bounding box 208 surrounds the kidney 202 in three dimensions.

Returning to FIG. 1, similar bounding boxes to that shown in FIG. 2 are drawn around each organ of interest in each of the training images. This can be performed using a dedicated annotation tool, which is a software program enabling fast drawing of the bounding boxes from different views of the image (e.g. axial, coronal, sagittal and 3D views). As the drawing of a bounding box is a simple operation, and does not need to be precisely aligned with the organ this can be efficiently manually performed. Radiologists can be used to validate that the labeling is anatomically correct.

A goal of the trained decision forest is to determine the centre of each organ in previously unseen images, and therefore the machine learning system is trained to identify organ centers from positive and negative training examples. The positive and negative examples are generated 102 from the annotated training images. This is illustrated in FIG. 2. The positive examples for an organ are generated by defining a positive bounding box 210 that is much smaller than the manually annotated bounding box 208 and has a central point located at the central point of the manually annotated bounding box 208. The positive bounding box 210 is shown with a double line in FIG. 2. In one example, the positive bounding box 210 is a fixed size for all organs (e.g. 5×5×5 voxels or 5×5 pixels). In another example, the positive bounding box 210 size is a proportion of the manually annotated bounding box 208 (e.g. 10% of the size). Each of the image elements (voxels or pixels) within (i.e. inside) this positive bounding box 210 are taken as positive examples of the organ center.

The negative examples for an organ are generated by defining a negative bounding box 212 that is smaller than the manually annotated bounding box 208, but larger than the positive bounding box 210, and has a central point located at the central point of the manually annotated bounding box 208. The negative bounding box is shown with a dot-dash line in FIG. 2. Each of the image elements (voxels or pixels) that are outside the negative bounding box 212 are taken as negative examples of the organ center. In one example, the negative bounding box 212 size is a proportion of the manually annotated bounding box 208 (e.g. 50% of the size). In an alternative example, the negative bounding box 212 is a fixed size for all organs.

Note that, in other examples, a labeled ground-truth database can be manually created without the use of bounding boxes. For example, a user can hand-label each image element in the training image instead of using bounding boxes. This technique can be useful for certain features, such as blood vessels, that cannot be readily captured within a bounding box.

Returning again to FIG. 1, the number of decision trees to be used in a random decision forest is selected 104. A random decision forest is a collection of deterministic decision trees. Decision trees can be used in classification algorithms, but can suffer from over-fitting, which leads to poor generalization. However, an ensemble of many randomly trained decision trees (a random forest) yields improved generalization. During the training process, the number of trees is fixed. In one example, the number of trees is ten, although other values can also be used.

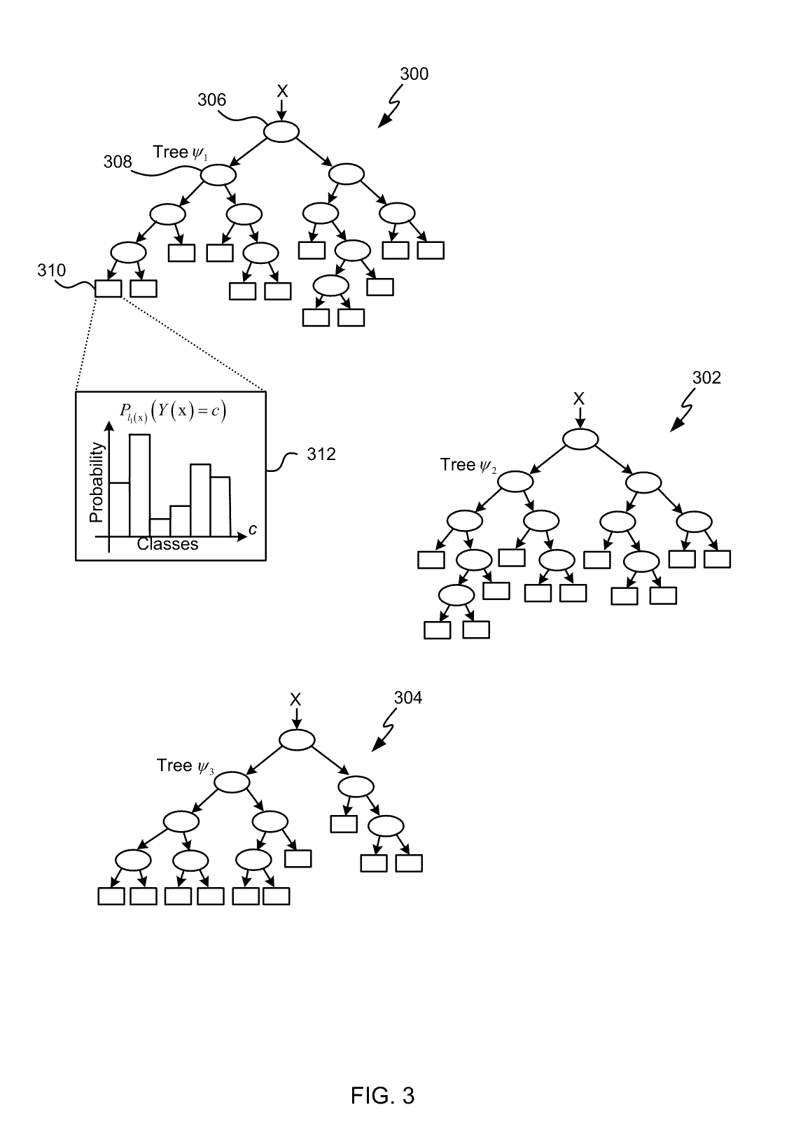

The following notation is used to describe the training process for a 3D volumetric image. Similar notation is used for a 2D image, except that the pixels only have x and y coordinates. An image element in a image V is defined by its coordinates x=(x,y,z). The forest is composed of T trees denoted Ψ₁, . . . , Ψₜ, . . . , Ψ_{T} with t indexing each tree. An example random decision forest is shown illustrated in FIG. 3. The illustrative decision forest of FIG. 3 comprises three decision trees: a first tree 300 (denoted tree Ψ₁); a second tree 302 (denoted tree Ψ₂); and a third tree 304 (denoted tree Ψ₃). Each decision tree comprises a root node (e.g. root node 306 of the first decision tree 300), a plurality of internal nodes, called split nodes (e.g. split node 308 of the first decision tree 300), and a plurality of leaf nodes (e.g. leaf node 310 of the first decision tree 300).

In operation, each root and split node of each tree performs a binary test on the input data and based on the result directs the data to the left or right child node. The leaf nodes do not perform any action; they just store probability distributions (e.g. example probability distribution 312 for a leaf node of the first decision tree 300 of FIG. 3), as described hereinafter.

The manner in which the parameters used by each of the split nodes are chosen and how the leaf node probabilities are computed is now described with reference to the remainder of FIG. 1. A decision tree from the decision forest is selected 106 (e.g. the first decision tree 300) and the root node 306 is selected 108. All image elements from each of the training images are then selected 110. Each image element x of each training image is associated with a known class label, denoted Y(x). The class label indicates whether or not the point x belongs to the positive set of organ centers, as defined by the positive bounding box 210 of FIG. 2. Thus, for example, Y(x) indicates whether an image element x belongs to the class of head, heart, left eye, right eye, left kidney, right kidney, left lung, right lung, liver, blood vessel, or background, where the background class label indicates that the point x is not an organ centre. For example, an image element belonging to the class ‘head’ are those found in the head positive bounding box, an image element belonging to the class ‘heart’ are those found in the heart positive bounding box, etc. The image elements of the background class are all negative examples (e.g. from negative bounding box 212) that are not positive examples for any organ, i.e. the background is the intersection of all sets of negative examples across all classes.

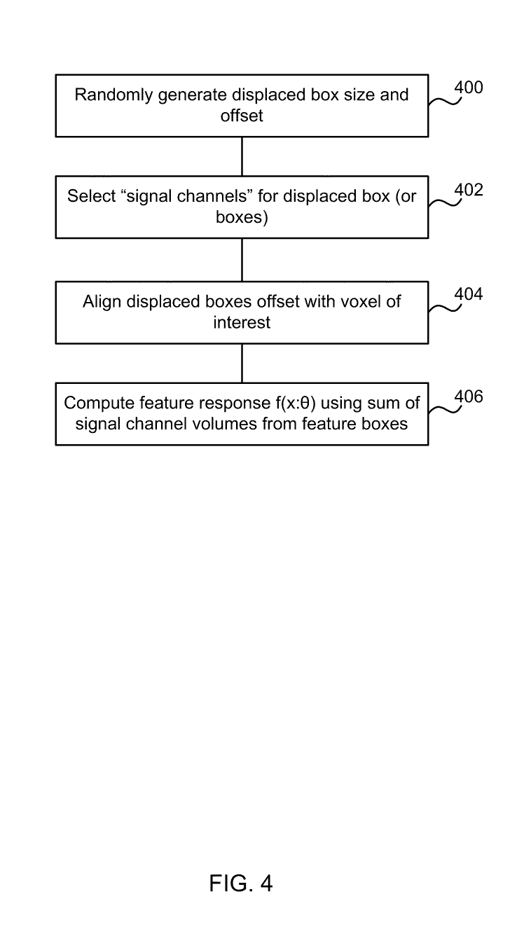

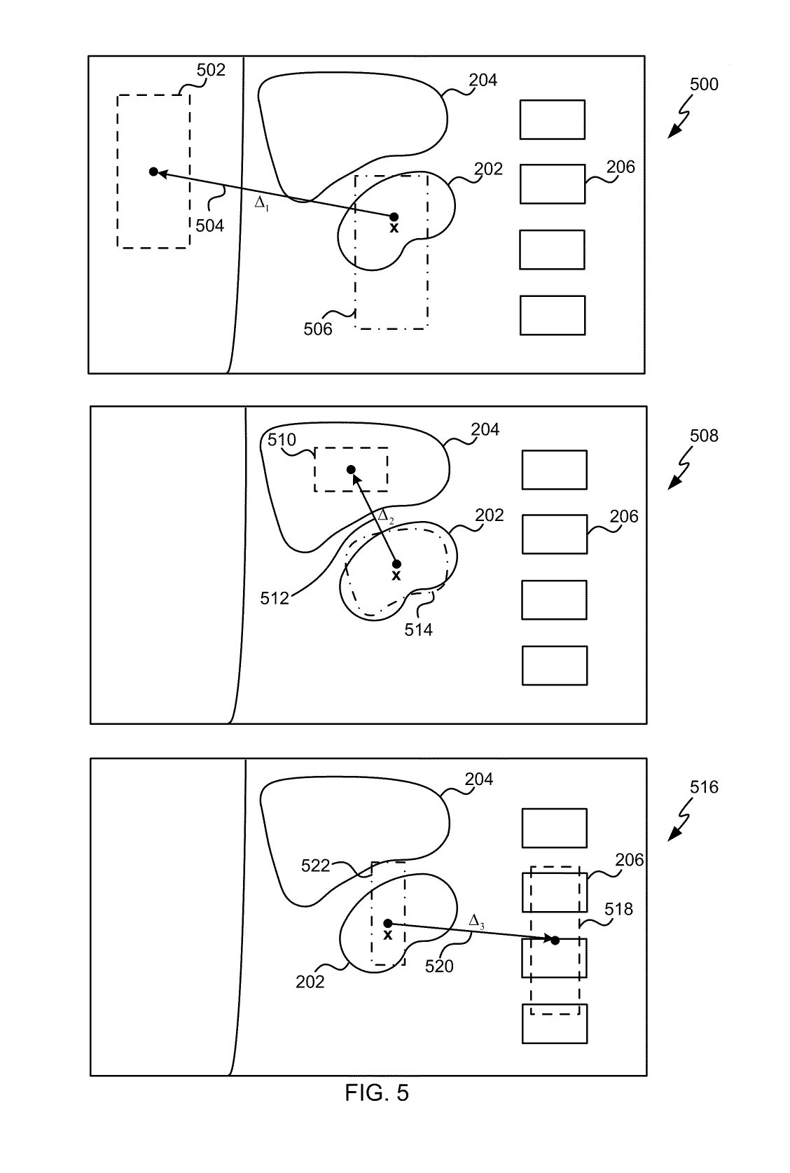

A random set of test parameters are then generated 112 for use by the binary test performed at the root node 306. In one example, the binary test is of the form: ξ>f (x; θ)>τ, such that f (x; θ) is a function applied to image element x with parameters θ, and with the output of the function compared to threshold values ξ and τ. If the result of f (x; θ) is in the range between ξ and τ then the result of the binary test is true. Otherwise, the result of the binary test is false. In other examples, only one of the threshold values ξ and τ can be used, such that the result of the binary test is true if the result of f (x; θ) is greater than (or alternatively less than) a threshold value. In the example described here, the parameter θ defines a visual feature of the image. An example function ƒ(x; θ) is described hereinafter with reference to FIGS. 4 and 5.

The result of the binary test performed at a root node or split node determines which child node an image element is passed to. For example, if the result of the binary test is true, the image element is passed to a first child node, whereas if the result is false, the image element is passed to a second child node.

The random set of test parameters generated comprise a plurality of random values for the function parameter θ and the threshold values ξ and τ. In order to inject randomness into the decision trees, the function parameters θ of each split node are optimized only over a randomly sampled subset Θ of all possible parameters. For example, the size of the subset Θ can be five hundred. This is an effective and simple way of injecting randomness into the trees, and increases generalization.

Then, every combination of test parameter is applied 114 to each image element in the training images. In other words, all available values for θ (i.e. θᵢεΘ) are tried one after the other, in combination with all available values of ξ and τ for each image element in each training image. For each combination, the information gain (also known as the relative entropy) is calculated. The combination of parameters that maximize the information gain (denoted θ*, ξ* and τ*) is selected 116 and stored at the current node for future use. As an alternative to information gain, other criteria can be used, such as Gini entropy, or the ‘two-ing’ criterion.

It is then determined 118 whether the value for the maximized information gain is less than a threshold. If the value for the information gain is less than the threshold, then this indicates that further expansion of the tree does not provide significant benefit. This gives rise to asymmetrical trees which naturally stop growing when no further nodes are needed. In such cases, the current node is set 120 as a leaf node. Similarly, the current depth of the tree is determined 118 (i.e. how many levels of nodes are between the root node and the current node). If this is greater than a predefined maximum value, then the current node is set 120 as a leaf node. In one example, the maximum tree depth can be set to 15 levels, although other values can also be used.

If the value for the maximized information gain is greater than or equal to the threshold, and the tree depth is less than the maximum value, then the current node is set 122 as a split node. As the current node is a split node, it has child nodes, and the process then moves to training these child nodes. Each child node is trained using a subset of the training image elements at the current node. The subset of image elements sent to a child node is determined using the parameters θ*, ξ* and τ* that maximized the information gain. These parameters are used in the binary test, and the binary test performed 124 on all image elements at the current node. The image elements that pass the binary test form a first subset sent to a first child node, and the image elements that fail the binary test form a second subset sent to a second child node.

For each of the child nodes, the process as outlined in blocks 112 to 124 of FIG. 1 are recursively executed 126 for the subset of image elements directed to the respective child node. In other words, for each child node, new random test parameters are generated 112, applied 114 to the respective subset of image elements, parameters maximizing the information gain selected 116, and the type of node (split or leaf) determined 118. If it is a leaf node, then the current branch of recursion ceases. If it is a split node, binary tests are performed 124 to determine further subsets of image elements and another branch of recursion starts. Therefore, this process recursively moves through the tree, training each node until leaf nodes are reached at each branch. As leaf nodes are reached, the process waits 128 until the nodes in all branches have been trained. Note that, in other examples, the same functionality can be attained using alternative techniques to recursion.

Once all the nodes in the tree have been trained to determine the parameters for the binary test maximizing the information gain at each split node, and leaf nodes have been selected to terminate each branch, then probability distributions can be determined for all the leaf nodes of the tree. This is achieved by counting 130 the class labels of the training image elements that reach each of the leaf nodes. All the image elements from all of the training images end up at a leaf node of the tree. As each image element of the training images has a class label associated with it, a total number of image elements in each class can be counted at each leaf node. From the number of image elements in each class at a leaf node and the total number of image elements at that leaf node, a probability distribution for the classes at that leaf node can be generated 132. To generate the distribution, the histogram is normalized. Optionally, a small prior count can be added to all classes so that no class is assigned zero probability, which can improve generalization.

An example probability distribution 312 is shown illustrated in FIG. 3 for leaf node 310. The probability distribution shows the classes of image element c against the probability of an image element belonging to that class at that leaf node, denoted as Pₗ_{ₜ}₍ₓ₎₍Y(x)=c), where lₜ indicates the leaf node l of the t^{th} tree. In other words, the leaf nodes store the posterior probabilities over the classes being trained. Such a probability distribution can therefore be used to determine the likelihood of an image element reaching that leaf node belonging to a given class of organ, as described in more detail hereinafter.

Returning to FIG. 1, once the probability distributions have been determined for the leaf nodes of the tree, then it is determined 134 whether more trees are present in the decision forest. If so, then the next tree in the decision forest is selected, and the process repeats. If all the trees in the forest have been trained, and no others remain, then the training process is complete and the process terminates 136.

Therefore, as a result of the training process, a plurality of decision trees are trained using training images. Each tree comprises a plurality of split nodes storing optimized test parameters, and leaf nodes storing associated probability distributions. Due to the random generation of parameters from a limited subset used at each node, the trees of the forest are distinct (i.e. different) from each other.

Reference is now made to FIGS. 4 and 5, which describe a function ƒ(x; θ) for use in the nodes of the decisions trees. The function described herein makes use of both the appearance of anatomical structures as well as their relative position or context in the medical image. Anatomical structures can be difficult to identify in medical images because different organs can share similar intensity values, e.g. similar tissue density in the case of CT and X-Ray scans. Thus, local intensity information is not sufficiently discriminative to identify organs, and further information such as texture, spatial context and topological cues are used to increase the identification success.

Reference is first made to FIG. 4, which illustrates a flowchart of a process for using spatial context in a image. As mentioned above, the parameters θ for the function ƒ(x; θ) are randomly generated during training. The process for generating the parameters θ comprises generating 400 a randomly-sized box (a cuboid box for 3D images, or a rectangle for 2D images, both of which can be extended in the time-dimension in the case of a sequence of images) and a spatial offset value. All dimensions of the box are randomly generated. The spatial offset value is in the form of a two- or three-dimensional displacement. In other examples, the parameters θ can further comprise one or more additional randomly generated boxes and a spatial offset values. In alternative examples, differently shaped regions (other than boxes) or offset points can be used.

Optionally, the process for generating the parameters θ can also comprise selecting 402 a ‘signal channel’ (denoted Cᵢ) for each of the above-mentioned boxes. The channels Cᵢ can be, for example, the image intensity at an image element x (denoted C(x)=I(x)) or the magnitude of the intensity gradient at image element x (denoted C(x)=|∇I(x)|). In other examples, more complex filters such as SIFT, HOG, T1, T2, and FLAIR can be used for the signal channel. In other examples, only a single signal channel can be used (e.g. intensity only) for all boxes.

The boxes are defined in terms of their size (e.g. in millimeters) rather than in terms of pixels. The boxes can therefore be scaled so that the physical imaging resolution of the scanner is accounted for. For example, a 10 mm box width in a 0.5 pixels/mm scanner would turn into a 5 pixel box. Given the above parameters θ, the result of the function ƒ(x; θ) is computed by aligning 404 the scaled, randomly generated box with the image element of interest x such that the box is displaced from the image element x in the image by the spatial offset value. The value for f (x; θ) is then found by summing 406 the values for the signal channel for the image elements encompassed by the displaced box (e.g. summing the intensity values for the image elements in the box). Therefore, for the case of a single box, f (x; θ)=Σ_{qεF}C(q), where q is an image element within box F. This summation is normalized by the number of pixels in the box, after the physical pixel resolution adaptation has been applied. This avoids different summations being obtained from volumes recorded at different resolutions.

In the case of two boxes, f (x; θ) is given by: f (x; θ)=Σ_{qεF}_{₁}C₁(q)−Σ_{qεF}_{₂}C₂(q), where F₁ is the first box, C₁ is the signal channel selected for the first box, F₂ is the second box, and C₂ is the signal channel selected for the second box. Again, these two summations are normalized separately by the respective number of pixels in each box, after the physical pixel resolution adaptation has been applied.

Similar summation formulae can be used for further boxes. An alternative to the summation that is more computationally efficient is to use integral images (also known as summed area tables). Integral images enable the computation of the identical summation above, but with only 8 pixel look-ups (in the case of 3D) as opposed to N pixel lookups (for a box containing N pixels).

An example calculation of f (x; θ) for three random sets of parameters is illustrated with reference to FIG. 5. FIG. 5 shows an example image with spatial context calculations for an image element. Note that the image in FIG. 5 is two-dimensional for clarity reasons only, and that in a 3D volumetric image example, the box is cuboid and the spatial offsets have three dimensions.

The images of FIG. 5 shows a coronal view of a patient's abdomen, showing a kidney 202, liver 204 and spinal column 206, as described above with reference to FIG. 2. In a first example 500, a set of parameters θ₁ have been randomly generated that comprise the dimensions of a first box 502, along with a first offset 504, denoted Δ₁. To compute f (x; θ) for an image element of interest x (which in this case is at the centre of the kidney) the first box 502 is positioned displaced from the image element x by the first offset 504. In this example, this places the box outside the patient's body in the image. The function ƒ(x; θ) is then given by the sum of the signal channel values (e.g. intensity values) inside the box 502 at that location.

For this example, the training algorithm learns that when the image element x is in the kidney 202, the first box 502 is in a region of low density (air). Thus the value of f (x; θ) is small for those points. During training the algorithm learns that first box 502 is discriminative for the position of the right kidney when associated with a small, positive value of the threshold ξ₁ (with τ₁=−∞).

The dot-dash region 506 shows the area containing image elements in which the binary test is true for the box 502 with a small, positive value of the threshold ξ₁ and τ₁=−∞. In other words, the region 506 shows the region in which f (x; θ) is less than ξ. This region extends upwards, downwards and leftwards from image element x until the first box 502 hits the top, bottom or left-hand side of the image, respectively. In addition, it extends rightwards until the box 502 meets the side of the body. When the first box 502 begins to include image elements from the body, then the sum of the values within it are no longer as low, and the value of f (x; θ) becomes larger. This results in the threshold ξ being exceeded, and the binary test fails.

In a second example 508, a second set of parameters θ₂ have been randomly generated that comprise a second box 510 with a second offset 512 (Δ₂), which places the second box 510 within the liver 204 for the image element of interest x. As above, values for the binary test thresholds ξ₂ and τ₂ are chosen such that the result is true when the second box 510 remains in the liver, as indicated by the dot-dash region 514.

Similarly, in a third example, a third set of parameters θ₃ have been randomly generated that comprise a third box 518 with a third offset 520 (Δ₃), which places the third box 518 within the spinal column 206 for the image element of interest x. As above, values for the binary test thresholds ξ₃ and τ₃ are chosen such that the result is true when the third box 518 remains in the spine, as indicated by the dot-dash region 522.

If these three randomly generated boxes and offsets are used in a decision tree, then the image elements that lie in the intersection of region 506, 514 and 522 satisfy all three binary tests, and can be taken in this example to have a high probability of being the centre of a kidney. Clearly, this example only shows some of the enormous possible combinations of boxes and offsets, and is merely illustrative. Nevertheless, this illustrates how the features in the images can be captured by considering the relative layout of visual patterns. For example, kidney patterns tend to occur a certain distance away, in a certain direction, from the edge of the body, liver patterns and spine patterns. Note that this algorithm is free to select features with very large offsets (within the image) which enables the capture of very long-range spatial interactions between features.

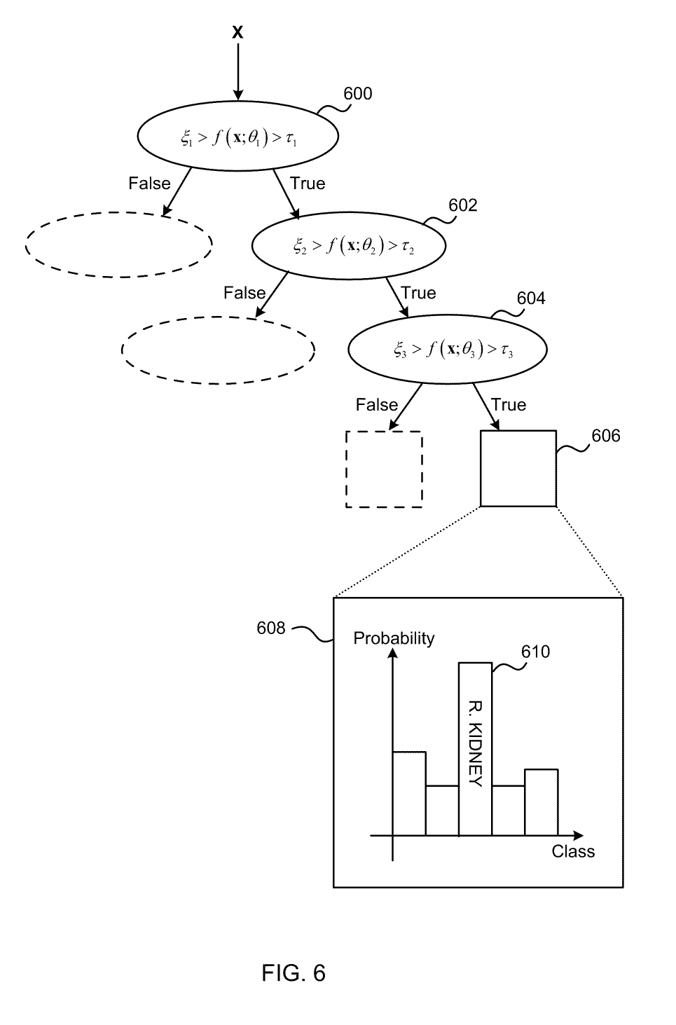

If during the training process described above, the algorithm were to select the three random parameters shown in FIG. 5 to use at three nodes of a decision tree, then these can be used to test an image element as shown in FIG. 6. FIG. 6 illustrates a decision tree having three levels, which uses the spatial context calculations of FIG. 5. The training algorithm has selected the first set of parameters θ₁ and thresholds ξ₁ and τ₁ from the first example 500 of FIG. 5 to be the test applied at a root node 600 of the decision tree of FIG. 6. As described above, the training algorithm selects this test as it had the maximum information gain for the training images. An image element x is applied to the root node 600, and the test performed on this image element. As shown in FIG. 5, image element x is in the region 506, and hence the result of the test is true. If the test was performed on an image element outside the region 506, then the result would have been false.

Therefore, when all the image elements from the image are applied to the trained decision tree of FIG. 6, the subset of image elements contained within region 506 (that pass the binary test) are passed to child split node 602, and the subset of image elements outside region 506 (that fail the binary test) are passed to the other child node.

The training algorithm has selected the second set of parameters θ₂ and thresholds ξ₂ and τ₂ from the second example 508 of FIG. 5 to be the test applied at the split node 602. As shown in FIG. 5, the image elements that pass this test are those contained within the region 514. Therefore, given that only the image elements contained in region 506 reach split node 602 from its parent node, the image elements that pass this test are those in the intersection of region 506 and region 514. Those image elements outside this intersection fail the test. The image elements in the intersection passing the test are provided to split node 604.

The training algorithm has selected the third set of parameters θ₃ and thresholds ξ₃ and τ₃ from the third example 516 of FIG. 5 to be the test applied at the split node 604. FIG. 5 shows that only those image elements within region 522 pass this test. However, as only the image elements that are in the intersection of region 506 and region 514 reach split node 604 from its patent, the image elements that pass the test at split node 604 are those at the intersection of region 506, region 514, and region 522. The image elements in this three-level intersection passing the test are provided to leaf node 606.

The leaf node 606 stores the probability distribution 608 for the different classes of organ. In this example, the probability distribution indicates a high probability 610 of image elements reaching this leaf node 606 being the center of a right kidney. This can be understood from FIG. 5, as only those image elements in the kidney have the spatial relationships with each of the edge of the body, liver and spine to pass all three tests and reach this leaf node.

In the above-described example of FIGS. 5 and 6, each of the tests are able to be performed as the image being tested contains substantially the same features as those used to train the tree. However, in some cases, a tree can be trained such that a test is used in a node that cannot be applied to a certain image. For example, if the decision tree of FIG. 6 were to be used on a image which was cropped close to the edge of the body, then the test at node 600 cannot be performed, as the image does not contain the data regarding the box 502 outside the body. In cases of crop and occlusion such as this, no test is performed and the image elements are sent to both the child nodes, so that further tests lower down the tree can still be used to obtain a result.

Clearly, FIGS. 5 and 6 provide a simplified example, and in practice a trained decision tree can have many more levels (and hence take into account much more spatial context). In addition, in practice, many decision trees are used in a forest, and the results combined to increase the accuracy, as outlined below with reference to FIG. 7.

FIG. 7 illustrates a flowchart of a process for identifying features in a previously unseen image using a decision forest that has been trained as described hereinabove. Firstly, an unseen image is received 700 at the feature identification algorithm. An image is referred to as ‘unseen’ to distinguish it from a training image which has the image elements already classified by hand. In other words, an unseen image is one without image element classification given by hand-labeling.

An image element from the unseen image is selected 702 for classification. A trained decision tree from the decision forest is also selected 704. The selected image element is pushed 706 through the selected decision tree (in a manner similar to that described above with reference to FIG. 6), such that it is tested against the trained parameters at a node, and then passed to the appropriate child in dependence on the outcome of the test, and the process repeated until the image element reaches a leaf node. Once the image element reaches a leaf node, the probability distribution associated with this leaf node is stored 708 for this image element.

If it is determined 710 that there are more decision trees in the forest, then a new decision tree is selected 704, the image element pushed 706 through the tree and the probability distribution stored 708. This is repeated until it has been performed for all the decision trees in the forest. Note that the process for pushing an image element through the plurality of trees in the decision forest can also be performed in parallel, instead of in sequence as shown in FIG. 7.

Once the image element has been pushed through all the trees in the decision forest, then a plurality of organ classification probability distributions have been stored for the image element (at least one from each tree). These probability distributions are then aggregated 712 to form an overall probability distribution for the image element. In one example, the overall probability distribution is the mean of all the individual probability distributions from the T different decision trees. This is given by:

$$P ( Y ( x ) = c ) = \frac{1}{T} {\sum }_{t = 1}^{T} {P}_{{l}_{t} ( x )} ( Y ( x ) = c )$$

Note that methods of combining the tree posterior probabilities other than averaging can also be used, such as multiplying the probabilities. Optionally, an analysis of the variability between the individual probability distributions can be performed (not shown in FIG. 7). Such an analysis can provide information about the uncertainty of the overall probability distribution. In one example, the standard deviation can be determined as a measure of the variability.

Once the overall probability distribution is determined, the presence (and if so classification) of an organ at the image element is detected 714. The detected classification for the image element is assigned to the image element for future use (outlined below). In one example, detecting the presence or absence of the center of an organ of a class c can be performed by determining the maximum probability in the overall probability distribution (i.e. P_{c}=maxₓP(Y(x)=c). In addition, the maximum probability can optionally be compared to a threshold minimum value, such that an organ having class c is considered to be present if the maximum probability is greater than the threshold. In one example, the threshold can be 0.5, i.e. the organ c is considered present if P_{c}>0.5. In a further example, a maximum a-posteriori (MAP) classification for an image element x can be obtained as c*=arg max_{c} P (Y(x)=c).

It is then determined 716 whether further unanalyzed image elements are present in the unseen image, and if so another image element is selected and the process repeated. Once all the image elements in the unseen image have been analyzed, then classifications and maximum probabilities are obtained for all image elements. The centre of an organ having a given classification can then be determined 718. This can be estimated using marginalization over the image V, given by:

x_{c}=∫_{V}xp(x|c)dx

Where x_{c} is the estimate of the central image element for class c, and the likelihood p(x|c)=P(Y(x)=c) by using Bayes rule and assuming a uniform distribution for the organs. Optionally, the probability p (x|c) can be raised to a power γ in the above equation, such that low probabilities are down-weighted in a soft manner, which can improve localization accuracy. In alternative examples, each class can be weighted based on its own volume in the set of training images. At this stage, the bounding box location can also be estimated by taking the average bounding box size over the training data, and centering that average bounding box on the detected organ center.

Once the process in FIG. 7 has completed, then all of the image elements of the unseen image are automatically classified, and the center of the organs estimated. The results of the automatic classification and organ centers can be utilized in an image viewer program, such as that illustrated in FIG. 8. FIG. 8 shows a display device 800 (such as a computer monitor) on which is shown a viewer user interface comprising a plurality of controls 802 and a display window 804. The viewer can use the results of the automatic classification and organ centers to control the display of a medical image shown in the display window 804. For example, the plurality of controls 802 can comprise buttons for each of the organs detected, such that when one of the buttons is selected the image shown in the display window 804 is automatically centered on the estimated organ center.

For example, FIG. 8 shows a ‘right kidney’ button 806, and when this is selected the image in the display window is centered on the right kidney. This enables a user to rapidly view the images of the kidney without spending the time to browse through the image to find the organ.

The viewer program can also use the image element classifications to further enhance the image displayed in the display window 804. For example, the viewer can color each image element in dependence on the organ classification. For example, image elements classed as kidney can be colored blue, liver colored yellow, blood vessels colored red, background grey, etc. Furthermore, the class probabilities associated with each image element can be used, such that a property of the color (such as the opacity) can be set in dependence on the probability. For example, an image element classed as a kidney with a high probability can have a high opacity, whereas an image element classed as a kidney with a low probability can have a low opacity. This enables the user to readily view the likelihood of a portion of the image belonging to a certain organ.

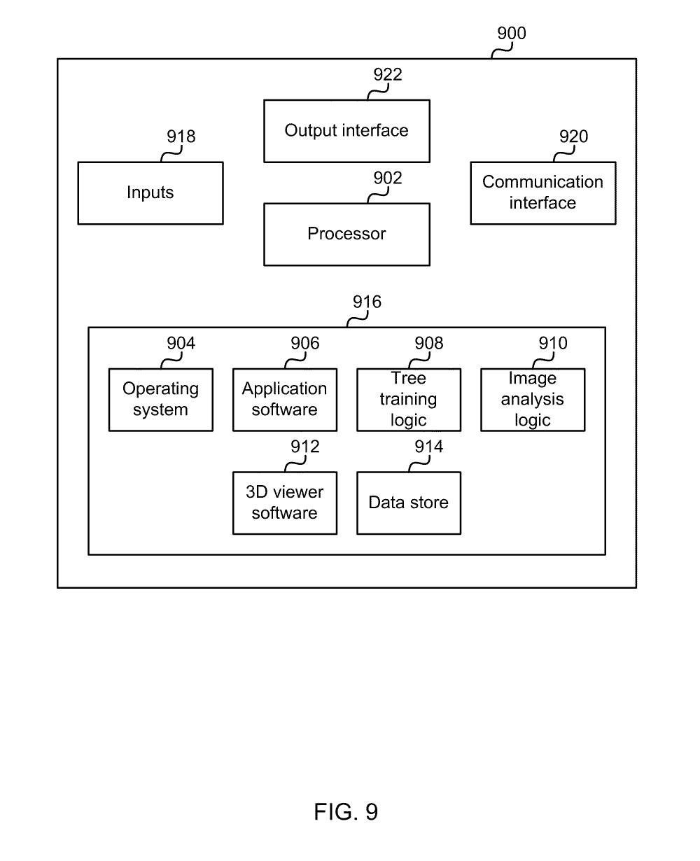

Reference is now made to FIG. 9, which illustrates various components of an exemplary computing-based device 900 which can be implemented as any form of a computing and/or electronic device, and in which embodiments of the image processing can be implemented. The computing-based device 900 illustrates functionality used for training a decision forest, analyzing images using the decision forest, and viewing images using the results of the analysis. However, this functionality can be implemented on separate computing-based devices if desired, and not on the same device as illustrated in FIG. 9.

Computing-based device 900 comprises one or more processors 902 which can be microprocessors, controllers or any other suitable type of processors for processing computing executable instructions configured to control the operation of the device in order to perform the image processing techniques. Platform software comprising an operating system 904 or any other suitable platform software can be provided at the computing-based device to enable application software 906 to be executed on the device.

Further software that can be provided at the computing-based device 900 includes tree training logic 908 (which implements the techniques described above with reference to FIG. 1-5), image analysis logic 910 (which implements the unseen image analysis of FIG. 6-7), and viewer software 912 (which implements the viewer of FIG. 8). A data store 914 is provided to store data such as the training parameters, probability distributions, and analysis results.

The computer executable instructions can be provided using any computer-readable media, such as memory 916. The memory is of any suitable type such as random access memory (RAM), a disk storage device of any type such as a magnetic or optical storage device, a hard disk drive, or a CD, DVD or other disc drive. Flash memory, EPROM or EEPROM can also be used.

The computing-based device 900 further comprises one or more inputs 918 which are of any suitable type for receiving user input, for example commands to control the training, analysis or image viewer. The computing-based device 900 also optionally comprises at least one communication interface 920 for communicating with one or more communication networks, such as the internet (e.g. using internet protocol (IP)) or a local network. The communication interface 920 can for example be arranged to receive an image for processing, e.g. from a computer network or from a storage media.

An output 922 is also optionally provided such as an video and/or audio output to a display system integral with or in communication with the computing-based device 900. The display system can provide a graphical user interface, or other user interface of any suitable type. The display system can comprise the display device 800 shown in FIG. 8 for displaying the user interface of the viewer.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A device for automatically identifying organs in a medical image, comprising:
a communication interface arranged to receive the medical image;
at least one processor; and
a memory arranged to store a decision forest comprising a plurality of distinct trained decision trees, and arranged to store executable instructions configured to cause the processor to: select an image element from the medical image; apply the image element to each of the trained decision trees to obtain a plurality of probabilities of the image element representing one of a plurality of predefined classes of organ; and aggregate the probabilities from each of the trained decision trees and assign an organ classification to the image element in dependence thereon.

2. A device according to claim 1, wherein the medical image is a three-dimensional volumetric image and the image element is a voxel.

3. A device according to claim 1, wherein the executable instructions are configured to cause the processor to aggregate the probabilities by averaging the probabilities from each of the trained decision trees.

4. A device according to claim 1, wherein the executable instructions are configured to cause the processor to assign an organ classification to the image element using at least one of: a maximum value from the aggregate probabilities; a threshold minimum value of the aggregate probabilities; and a maximum a-posteriori classification for the aggregate probabilities.

5. A device according to claim 1, wherein the executable instructions are further configured to cause the processor to repeat the select, apply, aggregate and assign operations for each image element in the medical image, and the executable instructions are further configured to estimate a location for the centre of a selected organ using the aggregate probabilities for each image element in the medical image.

6. A device according to claim 5, further comprising a display device, and wherein the executable instructions are further configured to cause the processor to display the medical image on the display device, centered on the location of the centre of the selected organ.

7. A device according to claim 1, wherein the executable instructions are configured to cause the processor to apply the image element to each of the trained decision trees by passing the image element through a plurality of nodes in each tree until a leaf node is reached in each tree, and wherein the plurality of probabilities are determined in dependence on the leaf node reached in each tree.

8. A device according to claim 7, wherein each of the plurality of nodes in each tree performs a test to determine a subsequent node to which to send the image element.

9. A device according to claim 8, wherein the test utilizes predefined parameters determined during a training process.

10. A computer-implemented method of training a decision tree to identify features within an image, comprising:
selecting a node of the decision tree;
selecting at least one image element in a training image;
generating a plurality of spatial offset values;
analyzing the training image at a plurality of locations to obtain a plurality of results, wherein each location is offset from the or each image element by a respective one of the spatial offset values;
selecting a chosen offset from the spatial offset values in dependence on the results; and
storing the chosen offset in association with the node at a storage device.

11. A method according to claim 10, wherein the step of analyzing the training image comprises at least one of: analyzing an intensity value of at least one image element; and analyzing a magnitude of an intensity gradient for at least one image element.

12. A method according to claim 10, wherein the image is a three-dimensional medical volumetric image, the or each image element is a voxel, and the features are organs.

13. A method according to claim 12, further comprising the step of generating a plurality of cuboid dimensions, and wherein each location comprises a portion of the volumetric image encompassed by a cuboid having a respective one of the plurality of cuboid dimensions.

14. A method according to claim 13, wherein the plurality of cuboid dimensions are randomly generated.

15. A method according to claim 13, wherein the step of analyzing comprises summing at least one parameter from each voxel in the cuboid at each location.

16. A method according to claim 10, wherein the step of selecting a chosen offset comprises determining an information gain for each of the plurality of results, and selecting the chosen offset as the spatial offset value giving the maximum information gain.

17. A method according to claim 16, wherein the step of determining an information gain for each of the plurality of results comprises: comparing each of the plurality of results to a plurality of threshold values to obtain a plurality of comparison values for each of the plurality of results; and determining an information gain for each of the plurality of comparison values.

18. A method according to claim 17, wherein the method further comprises: selecting a chosen threshold as the threshold value giving the maximum information gain; and storing the chosen threshold in association with the node at the storage device.

19. A method according to claim 16, further comprising repeating the steps of the method until the maximum information gain is less than a predefined minimum value or the node of the decision tree has a maximum predefined depth.

20. A computer-implemented method of automatically identifying a location of a center of an organ in a three-dimensional medical volumetric image, comprising:
receiving the three-dimensional medical volumetric image at a processor;
accessing a decision forest comprising a plurality of distinct trained decision trees stored on a storage device;
selecting a voxel from the medical volumetric image;
applying the voxel to each of the trained decision trees to obtain a plurality of probabilities of the voxel representing one of a plurality of predefined classes of organ;
aggregating the probabilities from each of the trained decision trees to obtain an overall organ probability for the voxel;
repeating the steps of selecting, applying and aggregating for each voxel in the medical volumetric image; and
estimating the location of the centre of the organ using the overall organ probability for each voxel in the medical volumetric image.
